(19) United States
(12) Patent Application Publication
(10) Pub. No.: US 2024/0230561 A1
(43) Pub. Date: Jul. 11, 2024

(54) IN-SITU NMR MEASUREMENT OF MINERALS AND OTHER SUBSTANCES

(71) Applicant: Vista Clara Inc.

(72) Inventors: David O. Walsh, Mukilteo, WA (US); Darya Morozov, Mill Creek, WA (US)

(73) Assignee: Vista Clara Inc., Mukilteo, WA (US)

(21) Appl. No.: 18/409,188

(22) Filed: Jan. 10, 2024

Related U.S. Application Data
(60) Provisional application No. 63/479,223, filed on Jan. 10, 2023.

(51) Int. Cl. G01N 24/08; G01V 3/32

(52) U.S. Cl. CPC G01N 24/084; G01V 3/32

(57) ABSTRACT

Technologies disclosed herein include in-situ nuclear magnetic resonance (NMR) mineral detection and measurement, for example, high field NMR technology for direct detection of lithium and other minerals in wells and Earth formations. The disclosed technology can be further applicable for detection of dissolved organic contaminants in groundwater resources.

### CROSS REFERENCE TO RELATED APPLICATION

This is a nonprovisional claiming priority under 35 U.S.C. § 119 of co-pending U.S. Provisional Patent Application No. 63/479,223, entitled “IN-SITU NMR MINERAL DETECTION AND MEASUREMENT”, filed on Jan. 10, 2023. The prior application is incorporated by reference herein in its entirety.

### BACKGROUND

The world's demand for lithium and other minerals is growing every day. For example, is expected that by 2030, the lithium market will grow by a factor of six as compared to 2020. Lithium and other mineral compounds have numerous industrial and pharmaceutical uses. For example, one significant use of lithium is in lithium-ion batteries for mobile devices and electric vehicles.

Much of the world's natural lithium resources are found in salt-lake brines, seawater, and geothermal water. It is important to determine the concentration of minerals such as lithium prior to pumping the brine or water to the surface for mineral extraction. Higher concentrations of minerals can reduce the amount of processing that is required and can also reduce wastes and overall cost.

In an example mineral extraction, once brine or water is pumped to the surface, it may be stored in a series of large ponds for evaporation. Mineral content can be sampled and monitored regularly by laboratory examinations. This monitoring process can involve significant manpower and can be cost and time consuming.

Meanwhile, there are also many mineral-based substances and contaminants, such as benzene, toluene, ethylbenzene and xylene (BTEX) substances, perfluoroalkyl and polyfluoroalkyl (PFAS) substances, hydrocarbons, and organic contaminants which are often found underground and whose concentrations are of interest for environmental and other purposes. Monitoring processes for these substances and contaminants can also involve significant manpower and can be cost and time consuming.

There is a need for more efficient and cost-effective measurement and monitoring techniques that can be used to monitor concentrations of lithium and other minerals and mineral-based substances.

### SUMMARY

Technologies disclosed herein include in-situ nuclear magnetic resonance (NMR) mineral detection and measurement, for example, high field NMR technology for direct detection of lithium and other minerals in wells and Earth formations. The disclosed technology can be further applicable for detection of any substances comprising non-hydrogen nuclei, such as dissolved organic contaminants in groundwater resources. Further aspects and variations are discussed in detail below.

### BRIEF DESCRIPTION OF THE DRAWINGS

Various features and attendant advantages of the disclosed technologies will become fully appreciated when considered in conjunction with the accompanying drawings, in which like reference characters designate the same or similar parts throughout the several views, and wherein:

FIG. 1 illustrates an example NMR system, in accordance with various aspects and embodiments of the subject disclosure.

FIG. 2 illustrates example equipment adapted for in-situ NMR detection, measurement and monitoring of minerals and other substances, in accordance with various aspects and embodiments of the subject disclosure.

FIG. 3 illustrates an example NMR sensor that can be used for detection, measurement and monitoring of minerals and other substances, in accordance with various aspects and embodiments of the subject disclosure.

FIG. 4 illustrates another example NMR sensor that can be used for detection, measurement and monitoring of minerals and other substances, in accordance with various aspects and embodiments of the subject disclosure.

FIG. 5 illustrates another example NMR sensor that can be used for detection, measurement and monitoring of minerals and other substances, in accordance with various aspects and embodiments of the subject disclosure.

FIG. 6 illustrates another example NMR sensor that can be used for detection, measurement and monitoring of minerals and other substances, in accordance with various aspects and embodiments of the subject disclosure.

FIG. 7 includes FIG. 7A, FIG. 7B, FIG. 7C, and FIG. 7D, and illustrates example coil geometries that can be used in connection with transmit/receive arrays included in NMR sensors, in accordance with various aspects and embodiments of the subject disclosure.

FIG. 8 is a block diagram illustrating an example computer.

### DETAILED DESCRIPTION

Prior to explaining embodiments of the invention in detail, it is to be understood that the invention is not limited to the details of construction or arrangements of the components and method steps set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

We identify NMR as a powerful in-situ technique for efficient detection, measurement, and monitoring of lithium and/or other substances comprising non-hydrogen nuclei in wells or Earth formations. Techniques disclosed herein can employ NMR sensors adapted to probe the responses of nuclei with non-zero spin number to magnetic field perturbations. NMR signals observed after the magnetic field perturbations may exhibit frequencies specific to certain nuclei and may decay over time as the nuclei relax to equilibrium.

Example substances comprising non-hydrogen nuclei which can be detected, measured, and monitored using the techniques disclosed herein include, without limitation, lithium and other mineral substances having nonzero nuclear spin, as well as hydrocarbon substances, various contaminants and organic contaminants, PFAS substances, and BTEX substances.

The United States Department of Energy promulgates a list of critical minerals which includes numerous minerals which can be detected, measured, and monitored using the techniques disclosed herein. Some example minerals include aluminum, antimony, arsenic, barite, beryllium, bismuth, cesium, chromium, cobalt, dysprosium, erbium, europium, fluorspar, gadolinium, gallium, germanium, graphite, hafnium, holmium, indium, iridium, lanthanum, lithium, lutetium, magnesium, manganese, neodymium, nickel, niobium, palladium, platinum, praseodymium, rhodium, rubidium, ruthenium, samarium, scandium, tantalum, tellurium, terbium, thulium, tin, titanium, tungsten, vanadium, ytterbium, yttrium, zinc, and zirconium. Some further example substances which can be detected, measured, and monitored using the techniques disclosed herein include silicon, phosphorous, potassium, uranium, and fluorine. While not all the above listed critical minerals necessarily have nonzero or otherwise measurable nuclear spin properties, those that have nonzero or otherwise measurable nuclear spin properties can be detected, measured, and monitored using the techniques described herein.

Techniques described herein will use lithium as an example mineral, with the understanding the techniques can also apply to detection and measurement of the other minerals and listed above, as well as to other substances comprising non-hydrogen nuclei. Lithium has two NMR-active isotopes. Lithium-6 has a spin of 1 and natural abundance of 7.6%. Lithium-7 has a spin of 3/2, and natural abundance of 92.4%. Because of its higher sensitivity, lithium-7 is preferable for NMR examinations. However, due to the smaller gyromagnetic ratio of lithium as compared to hydrogen, larger magnetic fields are needed to efficiently detect the relatively small NMR signal of lithium.

Measuring dissolved lithium in brine is feasible, although NMR measurement apparatus must use appropriate techniques, which differ from standard NMR techniques. For example, about 1% lithium signal can be obtained when a highly concentrated LiCl sample is scanned at 0.0114 T using long TR of 15 sec. The signal of lithium reduces with decreasing TR, as expected. Current NMR bore-logging tools use relatively weak magnetic fields to measure response of hydrogen nuclei to magnetic field perturbation. These weak magnetic fields are not sensitive enough to detect small lithium signals found in brine resources (300-7000 ppm).

The ability to increase the strength of the magnetic field of NMR bore-logging tools makes it feasible to implement NMR as a broad technology to directly detect lithium in brine. Also, the increased magnetic field of a NMR bore logging tool can optionally be applied to detect other substances, including, e.g., organic contaminants such as BTEX in groundwater resources.

Embodiments of this disclosure can include a mineral-sensitive NMR probe adapted to directly detect and measure mineral concentrations within wells and Earth formations, e.g., within brine extraction wells. Technology that is efficient for mineral detection, measurement and monitoring can employ innovations that enhance the sensitivity and efficiency of mineral detection and measurement. The technology can comprise, inter alia, high-frequency NMR electronics capable of operating in boreholes.

In some embodiments, the technology disclosed herein can provide a valuable tool for lithium detection at liquid brine reservoirs used in lithium extraction processes. The technology can include a robust high-resolution NMR technology that can be used to efficiently detect and monitor lithium concentrations to support the lithium extraction process.

In some embodiments, the technology disclosed herein can similar be applied for measurement of other underground minerals and substances, such as any of the minerals and substances disclosed herein, including, e.g., dissolved organic contaminants such as BTEX in ground water resources, and potentially other valuable brine-dissolved minerals including potassium and boron.

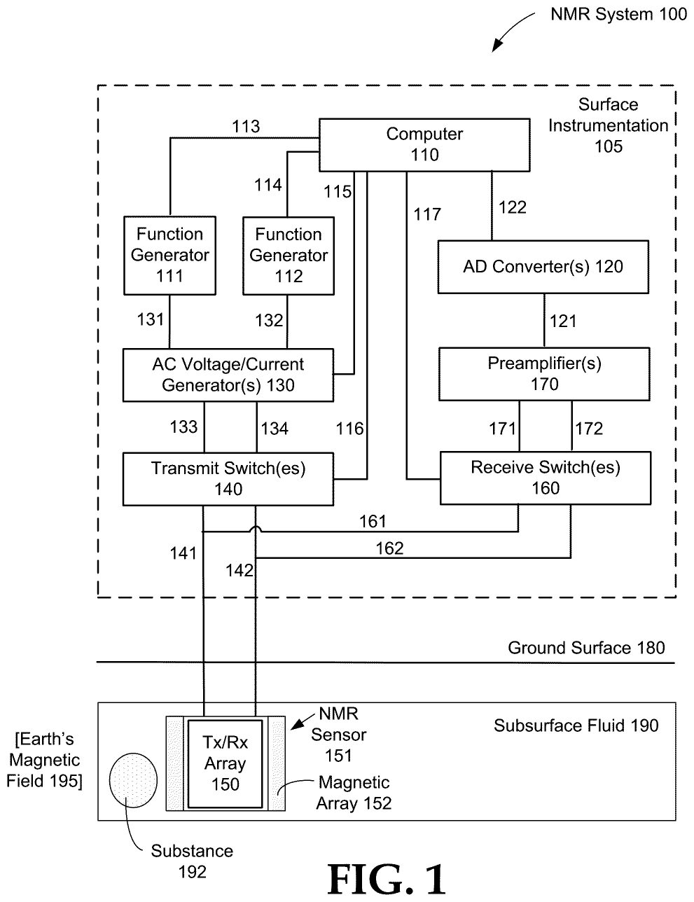

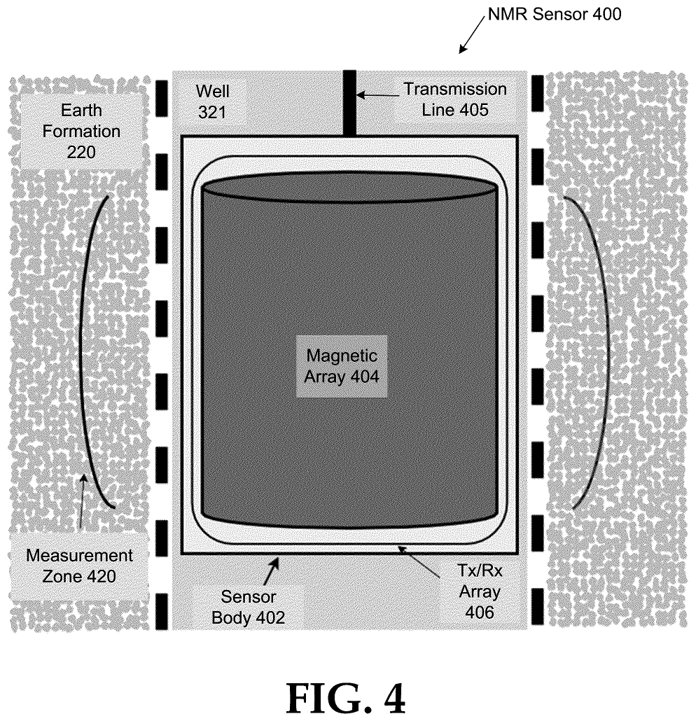

FIG. 1 illustrates an example NMR system, in accordance with various aspects and embodiments of the subject disclosure. The example NMR system 100 includes example surface instrumentation 105 positioned above a ground surface 180 and an NMR sensor 151 below the ground surface 180. The example NMR system 100 comprises a computer 110, function generators 111, 112, AC voltage/current generator(s) 130, transmit switch(es) 140, NMR sensor 151, receive switch(es) 160, preamplifier(s) 170, and Analog to Digital (AD) converter(s) 120. The NMR sensor 151 is illustrated in-situ under the ground surface 180. The NMR sensor 151 can comprise a transmit/receive (Tx/Rx) array 150 and a magnetic array 152 that produces a magnetic field in a sample volume within or proximal to the NMR sensor 151, as described in connection with FIGS. 4-7.

FIG. 1 furthermore depicts a subsurface fluid 190 beneath the ground surface 180. An example mineral or other substance 192 may be present in the subsurface fluid 190, and the substance 192 can be detected, measured, and/or monitored using the techniques disclosed herein. Earth's magnetic field 195 can be present both above and below the ground surface 180, and Earth's magnetic field 195 can optionally be used or accommodated in addition to the magnetic field applied by the magnetic array 152, in connection with some measurements performed by the NMR sensor 151.

In FIG. 1, the computer 110 is coupled to function generators 111, 112 by connections 113 and 114, respectively. The computer 110 is also coupled to AC voltage/current generator(s) 130 by connection 115, to transmit switch(es) 140 by connection 116, to receive switch(es) 160 by connection 117, and to AD converter(s) 120 by connection 122. Furthermore, function generators 111, 112 are coupled to AC voltage/current generator(s) 130 by connections 131 and 132, respectively. AC voltage/current generator(s) 130 are coupled to transmit switch(es) 140 by connections 133 and 134. Transmit switch(es) 140 are coupled to both ends of the Tx/Rx array 150 via connections 141 and 142. The ends of the Tx/Rx array 141 and 142 are coupled to receive switch(es) 160 by connections 161 and 162, respectively. Receive switch(es) 160 are coupled to preamplifier(s) 170 by connections 171 and 172. Preamplifier(s) 170 are coupled to AD converter(s) 120 by connection 121.

In general, with regard to FIG. 1, the NMR system 100 may be configured to produce electrical current pulse sequences on the Tx/Rx array 150. Each electrical current pulse sequence may comprise one or more oscillating electrical current pulses. When a pulse sequence comprises more than one pulse, the pulses may be separated by a pulse separation time. Also, pulse sequences may be separated by a pulse sequence separation time.

The computer 110 may be configured to produce a pulse by selecting a pulse phase and activating the AC voltage/current generator(s) 130. The computer 110 may be configured to select a pulse phase for example by activating a function generator 111 or 112 corresponding to a desired pulse phase, so that the selected function generator 111 or 112 provides an input pulse phase to the AC voltage/current generator(s) 130, which is then amplified by the AC voltage/current generator(s) 130 to produce a corresponding pulse on the Tx/Rx array 150. The computer 110 may also optionally be configured to close one or more transmit switch(es) 140 when activating the AC voltage/current generator(s) 130 and to open the transmit switch(es) 140 after activating the AC voltage/current generator(s) 130.

The computer 110 may be configured to produce a pulse sequence by producing a first pulse, then if additional pulses are included in the sequence, waiting for a predetermined pulse separation time, and then producing a next pulse, and repeating until the pulse sequence is complete. The computer 110 may be configured to produce two or more pulse sequences by producing a first pulse sequence, then waiting for a predetermined pulse sequence separation time, then producing a next pulse sequence, and repeating until a desired number of pulse sequences are complete.

The NMR system 100 may also be configured to receive and record NMR signal data received via the Tx/Rx array 150. The NMR system 100 may be configured to receive and record NMR signal data after one or more pulses within a pulse sequence, and/or after completion of a pulse sequence. In some embodiments, the computer 110 may be configured to close the receive switch(es) 160 after a pulse. The preamplifier(s) 170 amplify desired and undesired signals received via Tx/Rx array 150. The AD converter(s) 120 convert the received and amplified signals to digital NMR signal data, e.g., by sampling received signals at a desired sampling rate, and the computer 110 or other device equipped with storage media may be configured to store the digital NMR signal data.

In some embodiments, the computer 110 may be configured to process detected NMR signal data, e.g., to combine NMR signal data received and recorded after one or more pulses within a pulse sequence, and/or received and recorded after completion of pulse sequences, in such a way that preserves desired NMR signal data and cancels undesired NMR signal data. It will be appreciated that while the computer 110 may be configured to perform NMR processing, in some embodiments NMR acquisition and NMR processing may be performed separately, e.g., by first performing NMR acquisition with an NMR system 100, then processing acquired NMR data at a later time and/or with a different computing device.

In some embodiments, computer 110 may be programmed with software that controls the generation of pulse sequences and the acquisition of data. A set of data acquisition devices may comprise devices configured to generate the control signals for the pulse sequences, such as function generators 111, 112, and AD converter(s) 120 that receive, convert and/or record NMR signals.

The AC voltage/current generator(s) 130 may be configured to generate one or more current pulses in the Tx/Rx array 150 in a transmit mode, to induce a coherent precession of NMR spins in the subsurface fluid 190. Optional transmit switch(es) 140 may be configured to isolate transmitter noise from the receive circuitry during a receive mode.

Tx/Rx array 150 may be configured to cause a coherent precession of spins in a sample volume, such as the sample volume including substance 192. The sample volume can be in the subsurface fluid 190 as well as in a magnetic field produced by magnetic array 152. After causing the coherent precession of spins in the sample volume, Tx/Rx array 150 may be configured to also detect the NMR magnetic fields generated by the coherent precession of spins in the sample volume.

Optional receive switch(es) 160 may be configured to isolate the receive preamplifier(s) 170 from the potentially large voltage on the induction coil(s) 150 during transmit mode. Optional preamplifier(s) 170 may be configured to amplify the detected NMR signals prior to digitization by the AD converter(s) 120. The optional transmit switch(es) 140 and receive switch(es) 160 may comprise active devices such as relays, and/or passive devices such as diodes. Optional tuning capacitors, not shown in FIG. 1, may be used in the transmit mode to increase the transmitted current in the induction coil(s) 150, and/or in receive mode to increase the amplitude of the NMR signal voltage across the terminals of the Tx/Rx array 150.

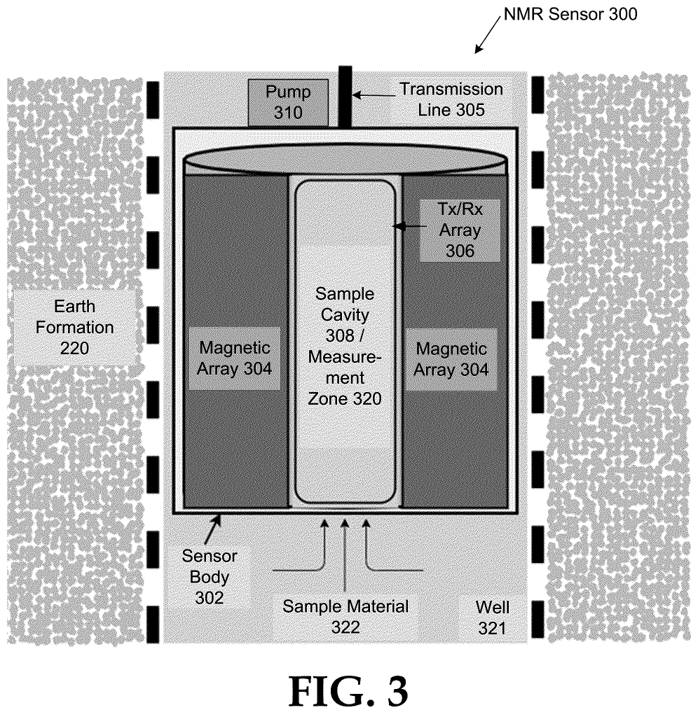

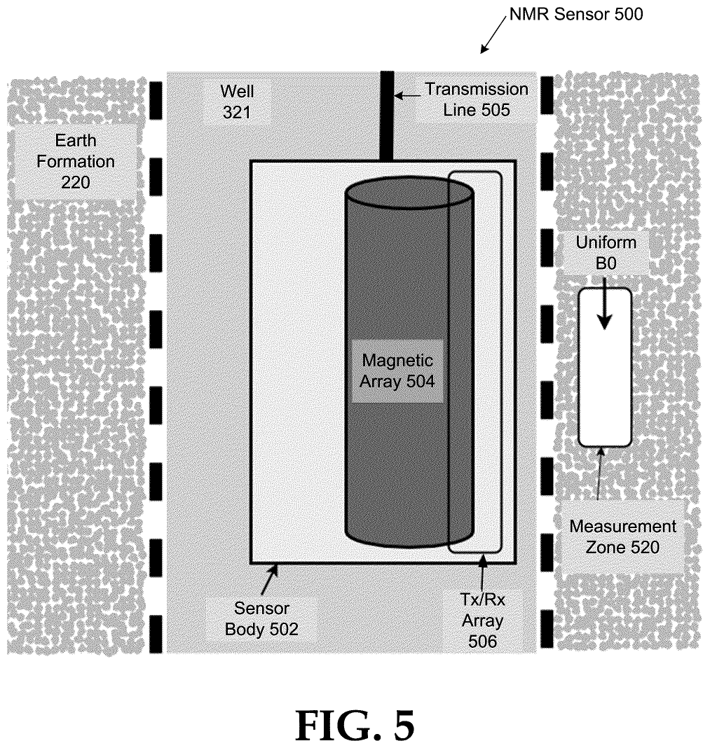

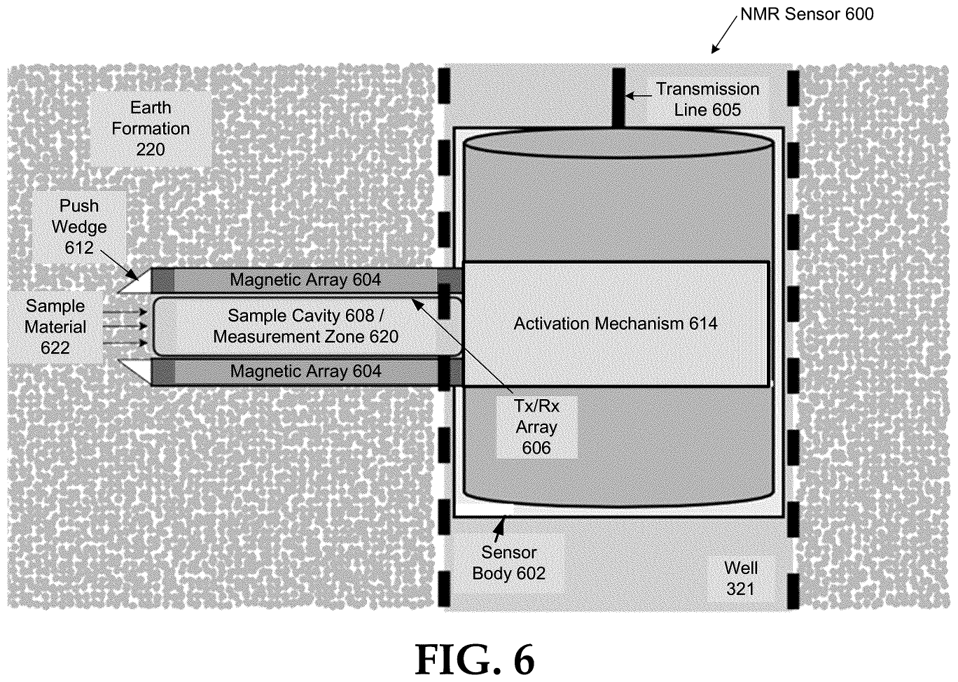

In some embodiments, Tx/Rx array 150 may comprise an NMR sensor such as illustrated in FIG. 3, FIG. 4, FIG. 5, or FIG. 6. In general, the Tx/Rx array 150 may comprise an array of coils comprising one or more transmit coils, one or more receive coils, and/or one or more combination transmit and receive coils. For example, Tx/Rx array 150 may comprise one transmit coil and multiple receive coils. Tx/Rx array 150 may comprise one combination transmit and receive coil, and multiple receive coils. Tx/Rx array 150 may comprise multiple combination transmit and receive coils. These and other multicoil arrangements may be configured in some embodiments as will be appreciated.

Any combination of hardware and software that enables the acquisition and processing of NMR signals from a substance 192 comprising lithium or other substances described herein within subsurface fluids such as 190, is suitable to implement embodiments of this disclosure. An architecture to implement the disclosed methods may comprise, for example, elements illustrated in FIG. 1, such as an AC voltage and current generator 130, a digital control system implemented at least in part by computer 110, a transmit switching circuit including transmit switch(es) 140, a receive switching circuit including receive switch(es) 160, a receive circuit including, e.g., Tx/Rx array 150, preamplifier(s) 170, a digital acquisition system including AD converter(s) 120, a digital storage device which may be implemented within computer 110 or other digital storage device, and a digital computer 110 equipped with pulse sequence control software and/or NMR processing software.

The switching circuits may transition a system such as NMR system 100 between a transmit-mode, when the Tx/Rx array 150 is connected to the transmit circuit, and receive-mode when the Tx/Rx array 150 is connected to the receive circuit. In a single acquisition sequence, the transmit circuit directs an AC current pulse or pulses with controlled amplitude and phase (alternating at the Larmor frequency) through the Tx/Rx array 150 in short succession. As quickly as possible after a given transmit pulse, and before the next pulse, the switching circuits may transfer the induction coil(s) 150 into a single- or multi-channel receive circuit. The data acquisition system may then record the voltages on the receive circuit and may record this received NMR signal data following the transmit pulse on the digital storage device. To form a complete cycled set, an acquisition sequence may be repeated one or more times, changing the phase of one or more transmit pulses between each acquisition sequence. After a complete cycled set corresponding to an NMR measurement is acquired, the signals recorded from each acquisition sequence may be linearly combined through digital processing.

In general, an NMR measurement may be collected by transmitting one or more pulses of alternating current through the Tx/Rx array 150. The alternating current may be tuned to the Larmor frequency of a substance 192 of interest, such as Lithium nuclei, and may generate a magnetic field alternating at the Larmor frequency. The alternating magnetic field radiates into the sample volume and modifies the nuclear magnetization state of the substance 192. The transmitted alternating magnetic field perturbs the magnetization from equilibrium alignment so that some component of the nuclear magnetization rotates into the transverse “xy” plane. Once rotated from equilibrium, the magnetization relaxes over time back to the equilibrium state over time, decaying from the transverse plane and re-growing along the longitudinal axis. The rotation of the magnetization by the transmitted pulse(s) and subsequent relaxation to equilibrium are described by the phenomenological Bloch equations. The evolution of the magnetization under the Bloch equations depends on several variables including the amplitude of the transmitted field, the duration and timing of the transmitted field, the phase of the transmitted field, the longitudinal relaxation time T1, FID relaxation rate T2*, and/or the spin-spin relaxation time T2 of the hydrogen nuclei under investigation.

An NMR signal is generated by the presence of coherent transverse magnetization following a transmit pulse. The transverse magnetization generates a magnetic field, which oscillates at the Larmor frequency, and generally has a phase related to the phase of one or more of the transmitted pulses. The surface instrumentation 105 records the NMR signal by monitoring the voltage on the Tx/Rx array 150. Identical measurements may be repeated to improve signal to noise; measurements using varied transmit currents may be used to modulate the contribution of different signals. Spatial inversion techniques may be used to isolate NMR signal contributions from different locations.

Measurement schemes with one or more excitation pulses may be used to probe different types of NMR responses and properties. In a single pulse measurement, a single pulse rotates a component of the magnetization into the transverse plane. The signal produced as this coherent transverse magnetization relaxes to equilibrium is called the Free Induction Decay (FID) signal. In the single pulse sequence, the pulse sequence is repeated only after a delay period that is sufficiently long to allow the longitudinal relaxation process of a sample to relax to their steady state. The FID signal can be used to determine the quantity of mineral content and the effective transverse relaxation time T2*. Double pulse sequences may be used to probe other relaxation times, such as T1 and/or T2. The first pulse rotates a component of the magnetization into the transverse plane; a second pulse transmitted after a controlled delay further modifies and rotates the magnetization state so that the recorded signal following the second pulse contains information about the decay times T1 and/or T2.

The surface instrumentation 105 may be referred to herein as a control hub, and the NMR sensor 151 can be configured as a portable NMR bore-logging sensor adapted for borehole logging, such as illustrated in FIG. 3, FIG. 4, FIG. 5, or FIG. 6. Both the surface instrumentation 105 and the NMR sensor 151 can be configured as described herein to directly detect and measure concentrations of the substance 192 in a subsurface sample, wherein the substance 192 may include lithium or other substances described herein. The technology disclosed herein can provide direct, quick, sensitive, and efficient detection and monitoring of lithium, other minerals, and/or organic contaminants within boreholes, exploration or extraction wells, or in in-situ deployments in which the NMR sensor 151 may be buried or otherwise permanently installed underground.

Embodiments of an NMR system 100 such as illustrated in FIG. 1 can comprise advanced hardware, firmware, and software designs to detect high-frequency NMR signals. Furthermore, embodiments can comprise noise reduction solutions that enable robust detection of small NMR signals. Noise reduction can comprise, e.g., hardware and software architectures to mitigate interference from radio-frequency emissions and infrastructure. Embodiments can employ acquisition methodologies for quantifying, mapping, and monitoring lithium, other minerals, and/or organic contaminants during borehole logging or other NMR measurement logging processes.

In some embodiments, high frequency NMR signals can be detected by direct sensing of analog signals using advanced hardware configured to apply sampling rates higher than a frequency of interest, e.g., twice the frequency of interest or more. In some embodiments, high frequency NMR signals can be detected by hardware configured to perform radio frequency mixing that converts signals from one frequency to another, e.g., by either modulating or demodulating signals.

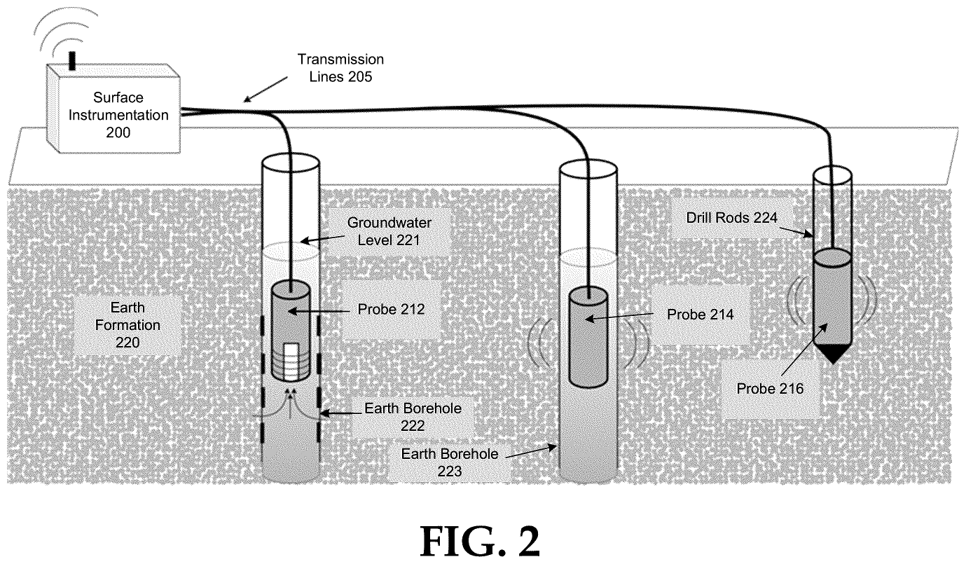

FIG. 2 illustrates example equipment adapted for in-situ NMR detection, measurement and monitoring of minerals and other substances, in accordance with various aspects and embodiments of the subject disclosure. FIG. 2 illustrates example surface instrumentation 200 deployed at the Earth surface. The surface instrumentation 200 is coupled via transmission lines 205 to three different example probes, e.g., probe 212, probe 214, and probe 216, wherein each of the probes 212, 214, 216 is deployed within an Earth formation 220. In some embodiments, the surface instrumentation 200 can be configured as described with reference to surface instrumentation 105 introduced in FIG. 1, and the probes 212, 214, 216 can be configured as described with reference to the NMR sensor 151 introduced in FIG. 1.

The three different probes 212, 214, 216 illustrate different example probe types, any of which can be used alone or with other probe types to perform NMR measurements according to this disclosure. Example probe types which can implement the probes 212, 214, and 216 are described below as well as with reference to FIG. 3, FIG. 4, FIG. 5, or FIG. 6.

A first example probe 212 can be adapted for deployment in an earth borehole 222 or well, e.g., inside a well casing. A borehole 222 can extend into the Earth formation 220 and can extend below a groundwater level 221. The first example probe 212 can be lowered below the groundwater level 221 and into water or brine. The first example probe 212 can be adapted to draw a sample, e.g. a sample of water or brine, inside the first example probe 212. In conjunction with the surface instrumentation 200, the first example probe 212 can be adapted to perform an NMR measurement on the sample inside the first example probe 212. FIG. 3 illustrates one configuration of the first example probe 212 in more detail.

A second example probe 214 can also be adapted for deployment in an earth borehole 223 or well, similar to the first example probe 212. In conjunction with the surface instrumentation 200, the second example probe 214 can be adapted to perform NMR measurements of a sample comprising the water and/or portion of the Earth formation 220 outside of and proximal to the second example probe 214. FIGS. 4 and 5 illustrate example configurations of the second probe 214 in more detail.

A third example probe 216 can comprise, e.g., a push type probe adapted to be pushed or drilled into the Earth formation 220. In conjunction with the surface instrumentation 200, the third example probe 216 can be adapted to perform NMR measurements of a sample comprising the water and/or portion of the Earth formation 220 outside of and proximal to the third example probe 216. In general, any of the techniques described in connection with the other probe types 212, 214 can optionally be applied in the context of a push type probe 216. Any of the probes/NMR sensors illustrated in FIGS. 3-6 can optionally be implemented as a push type probe 216.

FIGS. 3-6 illustrate various example NMR sensor configurations, which can implement the probes 212, 214, 216 illustrated in FIG. 2 in some embodiments. The illustrated example NMR sensors can be used as NMR logging tools in some embodiments. NMR logging tools can be configured for deployment in a well or Earth formation, and can be configured to detect, measure, and/or monitor dissolved NMR-sensitive minerals and concentrations thereof, or concentrations of other substances described herein, in groundwater, brine, or rock/earth inside or surrounding the well or Earth formation. The NMR logging tools can be configured according to this disclosure to be sensitive to non-hydrogen nuclei, such as the nuclei of lithium, phosphorus, potassium, or other substances described herein.

In general, the NMR logging tools illustrated in FIGS. 3-6 can each comprise an NMR sensor configured for deployment in a well or Earth formation, the NMR sensor comprising: a sensor body configured for deployment in the well or Earth formation; a magnetic array disposed inside the sensor body and adapted to produce a first magnetic field in a measurement zone; and a transmit/receive array disposed inside the sensor body. The transmit/receive array is adapted to produce a second magnetic field within the measurement zone, and to detect NMR signals emitted from a sample material within the measurement zone. The first magnetic field and the second magnetic field are adapted for direct detection of a substance comprising non-hydrogen nuclei, e.g., Lithium or the other substances herein, within the sample material and measurement of a concentration of a substance comprising non-hydrogen nuclei.

In configurations such as illustrated in FIG. 3, an NMR sensor can comprise a sample cavity within or adjacent the sensor body, and the NMR sensor can be configured to receive the sample material inside the sample cavity. In such configurations the measurement zone is inside the sample cavity. Configurations such as illustrated in FIG. 3 can optionally comprise a flow control device, such as a pump, configured to control a flow of the sample material into the sample cavity. Optionally, after NMR measurement of a sample material, the sample material can be pumped or otherwise ejected from the sample cavity, and fresh sample material can be subsequently introduced into the sample cavity for a subsequent NMR measurement.

In an example configuration, the magnetic array and the transmit/receive array can substantially surround the sample cavity as illustrated in FIG. 3. Alternatively, the sample cavity can be positioned for example underneath the magnetic array and the transmit/receive array.

In configurations such as illustrated in FIGS. 4 and 5, the measurement zone can be outside the sensor body. For example, FIG. 4 illustrates a configuration wherein the measurement zone comprises a zone which substantially surrounds the sensor body. The magnetic array can be substantially centered within the sensor body and the transmit/receive array can substantially surround the magnetic array, as illustrated in FIG. 4. Such embodiments may produce a nonzero spatial gradient within the measurement zone.

FIG. 5 illustrates a configuration wherein the measurement zone is outside the sensor body and is also focused and vertically elongated. The magnetic array is offset from a center of the sensor body and the transmit/receive array is positioned substantially alongside of the magnetic array.

In FIGS. 4 and 5, the measurement zone can be inside or outside the well or Earth formation in which the NMR logging tool is deployed. The measurement zone can comprise a “non-hydrogen sensitive zone” in which the NMR logging tool can produce NMR stimuli which are less sensitive to hydrogen nuclei, and more sensitive to nuclei of a target mineral or other substance for which NMR measurement is desired.

FIG. 6 illustrates a configuration wherein the magnetic array and the transmit/receive array are repositionable from within the sensor body into a sidewall of the well or Earth formation. Embodiments such as illustrated in FIG. 6 can include an activation mechanism adapted to reposition the magnetic array and the transmit/receive array. In the configuration illustrated in FIG. 6, an activatable measurement unit comprising a magnetic array, a Tx/Rx array, and a sample cavity can be displaced outside of a sensor body for measurement of sample materials adjacent a borehole sidewall.

NMR sensors configured according to any of FIGS. 3-6 can optionally be used in scenarios wherein the sample material comprises groundwater, slurry, earth, rock, or any other material and wherein the substance comprising non-hydrogen nuclei comprises a dissolved NMR-sensitive mineral that is dissolved in the groundwater. For example, the dissolved NMR-sensitive mineral can comprise at least one of lithium, phosphorus, or potassium.

Furthermore, at least some of the NMR sensors configured according to any of FIGS. 3-6 can produce a first magnetic field which is substantially uniform within the measurement zone, to reduce NMR signals produced by hydrogen nuclei. The substantially uniform magnetic field can be adapted to facilitate exclusion of NMR signals produced by hydrogen nuclei. The first magnetic field can have a spatial gradient which is approximately zero within the measurement zone.

Furthermore, transmit/receive arrays of NMR sensors configured according to any of FIGS. 3-6 can be coupled to surface electronics 200 via a transmission line 205, and the surface electronics 200 can be adapted to control NMR measurements.

Turning now to FIGS. 3-6 in further detail, FIG. 3 illustrates an example NMR sensor 300 that can be used for detection, measurement and monitoring of minerals and other substances, in accordance with various aspects and embodiments of the subject disclosure. The illustrated NMR sensor 300 can be coupled with surface instrumentation via a transmission line 305, such as illustrated by the probe 212, transmission lines 205 and surface instrumentation 200 in FIG. 2. The NMR sensor 300 can be positioned in-situ and optionally below water level within a well 321 or borehole that extends into an Earth formation 220, as illustrated in FIG. 2.

The NMR sensor 300 illustrated in FIG. 3 can comprise a sensor body 302 that is adapted to receive a sample material 322, e.g., groundwater, brine, or any other sample material, into a sample cavity 308, wherein the measurement zone 320 of the NMR sensor 300 is inside the sample cavity 308. A pump 310, a door, and/or another flow control device can optionally be used to draw the sample material 322 into the sample cavity 308.

The NMR sensor 300 can comprise a magnetic array 304 that produces a substantially uniform magnetic field in the measurement zone 320. The magnetic array 304 can optionally comprise a cylindrically shaped magnet arrangement that surrounds the sample cavity 308.

The NMR sensor 300 can further comprise a transmit/receive (Tx/Rx) array 306, which can comprise, e.g., one or more switchable wire coils configured to alternately apply NMR pulses in the measurement zone 320. The Tx/Rx array 306 can furthermore receive NMR response signals emitted by an excited sample in the measurement zone 320. The Tx/Rx array 306 can be coupled with the transmission line 305 and can be controllable by surface instrumentation, e.g., by the surface instrumentation 200 illustrated in FIG. 2. The surface instrumentation 200 can be adapted to control the Tx/Rx array 306 according to NMR measurement techniques that may be tuned for detection and measurement of minerals in the measurement zone 320, as described herein.

The electromagnetic pulse frequencies and magnetic field strengths applied by the NMR sensor 300 can vary in different embodiments. Factors to consider when configuring frequencies and magnetic field strengths include size of the measurement zone 320 and the target substance to be measured within the sample material 322. For example, for measurements of 7Li, magnetic fields between 0.5-1.5 T and frequencies in a range of 8.3-24.8 MHz may be applied. For measurements of 1H, magnetic fields between 0.5-1.5 T and frequencies in a range of 21.3-63.9 MHz may be applied.

FIG. 4 illustrates another example NMR sensor 400 that can be used for detection, measurement and monitoring of minerals and other substances, in accordance with various aspects and embodiments of the subject disclosure. Similar to the NMR sensor 300 of FIG. 3, the NMR sensor 400 illustrated in FIG. 4 can be coupled with surface instrumentation via a transmission line 405, such as illustrated by the probe 214, transmission lines 205 and surface instrumentation 200 in FIG. 2. Furthermore, the NMR sensor 400 can be positioned in-situ and optionally below water level within a well 321 or borehole that extends into an Earth formation 220, as illustrated in FIG. 2.

The NMR sensor 400 illustrated in FIG. 4 can comprise a sensor body 402 that houses a magnetic array 404 and a Tx/Rx array 406 adapted to perform measurements on a liquid sample, e.g., groundwater or brine, in a sample volume proximal to the sensor body 402 such as the sample volume within the measurement zone 420. The magnetic array 404 can be configured to produce a magnetic field in the sample volume within the measurement zone 420.

The Tx/Rx array 406 can comprise, e.g., one or more switchable wire coils configured to alternately apply NMR pulses in the sample volume within the measurement zone 420. The Tx/Rx array 406 can then receive, via the switchable wire coils, NMR response signals from the sample volume within the measurement zone 420. The Tx/Rx array 406 can be coupled with the transmission line 405 and can be controllable by the surface instrumentation 200. The surface instrumentation 200 can be adapted to control the Tx/Rx array 406 according to NMR measurement techniques that are tuned for detection and measurement of minerals and other substances in the measurement zone 420, as described herein.

The electromagnetic pulse frequencies and magnetic field strengths applied by the NMR sensor 400 can vary in different embodiments. Factors to consider when configuring frequencies and magnetic field strengths include size of the measurement zone 420 and the target substance to be measured within the measurement zone 420. For example, for measurements of 7Li, magnetic fields between 0.2-0.7 T and frequencies in a range of 8.3-24.8 MHz may be applied. For measurements of 1H, magnetic fields between 0.2-0.7 T and frequencies in a range of 8.5-29.8 MHz may be applied.

FIG. 5 illustrates another example NMR sensor 500 that can be used for detection, measurement and monitoring of minerals and other substances, in accordance with various aspects and embodiments of the subject disclosure. Similar to the NMR sensors of FIGS. 3 and 4, the NMR sensor 500 illustrated in FIG. 5 can be coupled with surface instrumentation via a transmission line 505, such as illustrated by the probe 214, transmission lines 205 and surface instrumentation 200 in FIG. 2. The NMR sensor 500 can be positioned in-situ and optionally below water level within a well 321 or borehole that extends into an Earth formation 220, as illustrated in FIG. 2.

The NMR sensor 500 illustrated in FIG. 5 can comprise a sensor body 502 that houses a magnetic array 504 and a Tx/Rx array 506 adapted to perform measurements on a liquid sample, e.g., groundwater or brine, in a sample volume proximal to the sensor body 502 such as in the measurement zone 520. In FIG. 5, the magnetic array 504 and the Tx/Rx array 506 are positioned and/or oriented to one side of the sensor body 502.

The magnetic array 504 can be positioned and configured to produce a substantially uniform BO magnetic field in the measurement zone 520. The measurement zone 520 can comprise a non-Hydrogen sensitive zone or “sweet spot” proximal the sensor body 502. Furthermore, the Tx/Rx array 506 can be positioned and configured to measure NMR signals produced in the measurement zone 520.

Otherwise, similar to the other Tx/Rx arrays discussed herein, the Tx/Rx array 506 can comprise one or more switchable wire coils configured to alternately apply NMR pulses in a sample volume, followed by receiving NMR response signals from the sample volume. The Tx/Rx array 506 can be coupled with the transmission line 505 and can be controllable by the surface instrumentation 200. The surface instrumentation 200 can be adapted to control the Tx/Rx array 506 according to NMR measurement techniques that are tuned for detection and measurement of minerals and other substances in the measurement zone 520, as described herein.

The electromagnetic pulse frequencies and magnetic field strengths applied by the NMR sensor 500 can vary in different embodiments. Factors to consider when configuring frequencies and magnetic field strengths include size of the measurement zone 520 and the target substance to be measured within the measurement zone 520. For example, for measurements of 7Li, magnetic fields between 0.5-1.5 T and frequencies in a range of 8.3-24.8 MHz may be applied. For measurements of 1H, magnetic fields between 0.5-1.5 T and frequencies in a range of 21.3-63.9 MHz may be applied.

FIG. 6 illustrates another example NMR sensor 600 that can be used for detection, measurement and monitoring of minerals and other substances, in accordance with various aspects and embodiments of the subject disclosure. Similar to the NMR sensors of FIGS. 3, 4, and 5, the NMR sensor 600 illustrated in FIG. 6 can be coupled with surface instrumentation via a transmission line 605, such as illustrated by the probe 214, transmission lines 205 and surface instrumentation 200 in FIG. 2. The NMR sensor 600 can be positioned in-situ and optionally below water level within a well 321 or borehole that extends into an Earth formation 220, as illustrated in FIG. 2.

The NMR sensor illustrated in FIG. 6 can comprise a sensor body 602 that houses a magnetic array 604 and a Tx/Rx array 606 adapted to perform measurements on a sample material 622, e.g., groundwater, brine, or another material, in a sample volume within a sample cavity 608, wherein the measurement zone 620 of the NMR sensor 600 is within the sample cavity 608. In FIG. 6, the magnetic array 604 and the Tx/Rx array 606 are adapted to respond to a remote activation, e.g., from the surface instrumentation 200, by repositioning from inside the sensor body 602 to outside of the sensor body 602. For example, the magnetic array 604 and the Tx/Rx array 606 can be pushed by an activation mechanism 614 into the Earth formation 220 adjacent the sensor body 602, as shown in FIG. 6. A push wedge 612 and/or other structures can optionally be used to facilitate and support deployment of the magnetic array 604 and the Tx/Rx array 606 into the Earth formation 220.

The NMR sensor 600 can optionally include the activation mechanism 614 to move the magnetic array 604 and the Tx/Rx array 606 into the surrounding Earth formation 220. The magnetic array 604 can be configured to produce a substantially uniform BO magnetic field in a sample cavity 608. The sample cavity 608 can comprise a non-Hydrogen sensitive zone inside the magnetic array 604.

Furthermore, the Tx/Rx array 606 can be configured to measure NMR signals produced in the sample cavity 608. Otherwise, similar to the other Tx/Rx arrays discussed herein, the Tx/Rx array 606 can comprise one or more switchable wire coils configured to alternately apply NMR pulses in the sample cavity 608 and then receive NMR response signals from the sample cavity 608. The Tx/Rx array 606 can be coupled with the transmission line 605 and can be controllable by the surface instrumentation 200. The surface instrumentation 200 can be adapted to control the Tx/Rx array 606 according to NMR measurement techniques that are tuned for detection and measurement of minerals and other substances in the sample cavity 608, as described herein.

The electromagnetic pulse frequencies and magnetic field strengths applied by the NMR sensor 600 can vary in different embodiments. Factors to consider when configuring frequencies and magnetic field strengths include size of the sample cavity 608 and the target substance to be measured within the sample material 622. For example, for measurements of 7Li, magnetic fields between 0.5-1.5 T and frequencies in a range of 8.3-24.8 MHz may be applied. For measurements of 1H, magnetic fields between 0.5-1.5 T and frequencies in a range of 21.3-63.9 MHz may be applied.

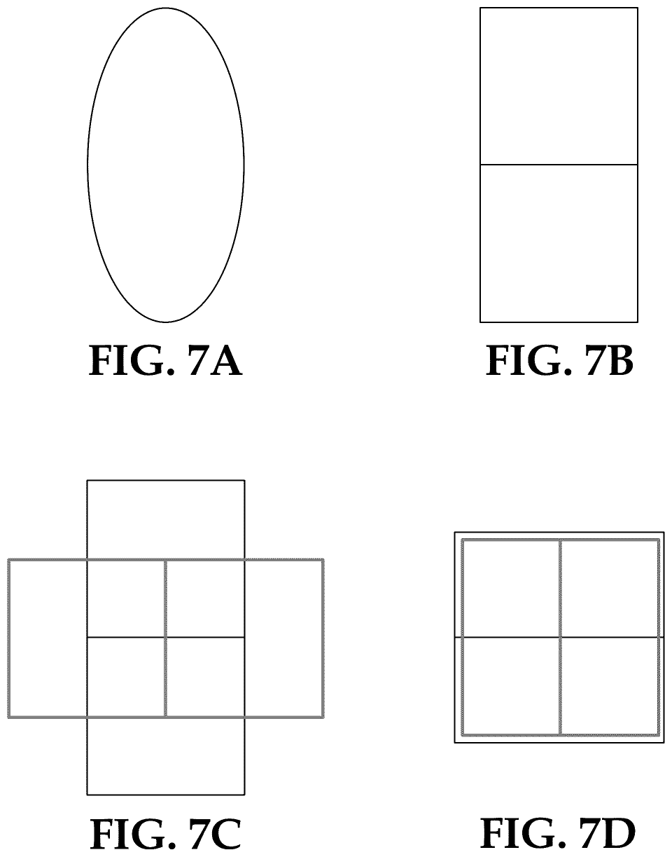

FIG. 7 includes FIG. 7A, FIG. 7B, FIG. 7C, and FIG. 7D, and illustrates example coil geometries that can be used in connection with transmit/receive arrays included in NMR sensors, in accordance with various aspects and embodiments of the subject disclosure. FIG. 7A illustrates a loop geometry. FIG. 7B illustrates a figure-eight geometry. FIG. 7C illustrates a first double figure-eight geometry. FIG. 7D illustrates a second double figure-eight geometry.

Any of the example coil geometries illustrated in FIG. 7 can be used in any of the NMR sensors disclosed herein. The coil geometries illustrated in FIGS. 7B, 7C, and 7D may be usefully applied in embodiments of the NMR sensor 500 illustrated in FIG. 5, in particular. The coil geometry illustrated in FIG. 7A may be usefully applied in embodiments of the NMR sensors 300, 400, and 600 illustrated in FIGS. 3, 4, and 6, in particular. Furthermore any of the illustrated coil geometries can be modified as needed to adapt to different sensor body shapes, and can include any desired number of coil turns.

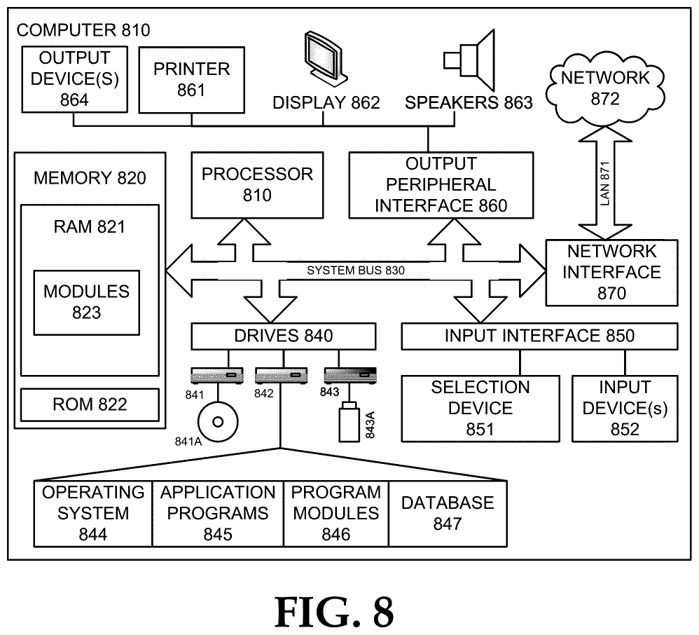

FIG. 8 is a block diagram illustrating an example computer, in accordance with various aspects and embodiments of the subject disclosure. The example computer 810 can implement the computer 110 illustrated in FIG. 1. As discussed in connection with FIG. 1, the computer 110 may be configured to produce pulse sequences, to receive and record resulting NMR signal data, and/or to perform processing of NMR signal data.

Computing device 810 may include for example a processor 810, memory 820, system bus 830, one or more drives 840, user input interface 850, output peripheral interface 860, and network interface 870. Drives 840 may include, for example, a compact disk drive 841 which accepts an optical disk 841A, a so-called hard drive 842, which may employ any of a diverse range of computer readable media, and a flash drive 843 which may employ for example a Universal Serial Bus (USB) type interface to access a flash memory 843A. Drives may further include network drives and virtual drives (not shown) accessed via the network interface 870.

The drives 840 and their associated computer storage media provide storage of computer readable instructions, data structures, program modules and other data for the computer system 810. For example, a hard drive 842 may include an operating system 844, application programs 845, program modules 846, and database 847. Software aspects of the technologies described herein may be implemented, in some embodiments, as computer readable instructions stored on any of the drives 840 or on network 872, which instructions may be loaded into memory 820, for example as modules 823, and executed by processor 810.

Computer system 810 may further include a wired or wireless input interface 850 through which selection devices 851 and input devices 852 may interact with the other elements of the system 810. Selection devices 851 and input devices 852 can be connected to the input interface 850 which is in turn coupled to the system bus 830, allowing devices 851 and 852 to interact with processor 810 and the other elements of the system 810. Interface and bus structures that may be utilized to implement 850 may include for example a Peripheral Component Interconnect (PCI) type interface, parallel port, game port and a wired or wireless Universal Serial Bus (USB) interface.

Selection devices 851 such as a mouse, trackball, touch screen, or touch pad allow a user to select among desired options and/or data views that may be output by the computer 810, for example via the display 862. Input devices 852 can include any devices through which commands and data may be introduced to the computer 810. For example, in some embodiments the AD converter(s) 120 may be coupled to the computer 810 as an input device 852, and data received from the AD converter(s) 120 may be stored in drives 840. Other example input devices 852 include a keyboard, an electronic digitizer, a microphone, a joystick, game pad, satellite dish, scanner, media player, mobile device, or the like.

Computer system 810 may also include an output peripheral interface 860 which allows the processor 810 and other devices coupled to bus 830 to interact with output devices such as the function generators 111, 112, the AC voltage/current generator(s) 130, the transmit switches 140, the receive switches 160, and optionally a Digital to Analog (DA) converter as discussed further herein. Other example output devices include printer 861, display 862, and speakers 863. Interface and bus structures that may be utilized to implement 860 include those structures that can be used to implement the input interface 850. It should also be understood that many devices are capable of supplying input as well as receiving output, and input interface 850 and output interface 860 may be dual purpose or support two-way communication between components connected to the bus 830 as necessary.

Computing system 810 may operate in a networked environment using logical connections to one or more computers. By way of example, FIG. 8 shows a LAN 871 connection to a network 872. A remote computer may also be connected to network 871. The remote computer may be a personal computer, a server, a router, a network PC, a peer device or other common network node, and can include many or all of the elements described above relative to computing system 810. Networking environments are commonplace in offices, enterprise-wide area networks (WAN), local area networks (LAN), intranets and the Internet.

When used in a LAN or WLAN networking environment, computing system 810 is connected to the LAN through a network interface 870 or an adapter. When used in a WAN networking environment, computing system 810 typically includes a modem or other means for establishing communications over the WAN, such as the Internet or network 872. It will be appreciated that other means of establishing a communications link between computers may be used.

In some embodiments, computing system 810 may include modules 846 and/or 823 comprising, inter alia, one or more NMR acquisition modules, and one or more NMR signal data processing modules. The NMR acquisition modules may be configured to control transmitting of two or more electrical current pulse sequences applicable by an NMR sensor. For example, the NMR acquisition modules may be configured to control the phases of pulses with each pulse sequence, the time between pulses, the number of pulses, the number of pulse sequences, and the time between pulse sequences. The NMR acquisition modules may be configured receive a pulse sequence selection or configuration from a user input, and may control the two or more electrical current pulse sequences according to the user selection. The NMR acquisition modules may be configured to send control signals to the various devices illustrated in FIG. 1 to control pulse sequence transmission.

In some embodiments, the NMR acquisition modules may also be configured to control receiving and recording signal data received in response to transmitted pulse sequences. For example, the NMR acquisition modules may be configured to operate receive switches 160, to place the NMR system 100 in a receive mode to detect signals after and/or during each of the electrical current pulse sequences. Detected signals may be converted to signal data by the AD converter(s) 120, and the signal data may be recorded in a memory of the computing device 810 or elsewhere.

In some embodiments, NMR processing modules may be configured to linearly combine detected signal data corresponding to separate electrical current pulse sequences to produce combined signal data in which one or more detected signal components are preserved and one or more different detected signal components are reduced or cancelled. The preserved signal components may comprise, for example, NMR signal data, such as desired NMR data, and the reduced or cancelled signal components may comprise undesired NMR signal data and/or non-NMR signal data. Alternatively, the preserved signal components comprise undesired NMR signal data and/or non-NMR signal data, the reduced or cancelled signal components comprise NMR signal data.

There is little distinction left between hardware and software implementations of aspects of systems; the use of hardware or software is generally (but not always) a design choice representing cost vs. efficiency tradeoffs. There are various vehicles by which processes and/or systems and/or other technologies described herein can be effected (e.g., hardware, software, and/or firmware), and that the preferred vehicle may vary with the context in which the processes and/or systems and/or other technologies are deployed. For example, if an implementer determines that speed and accuracy are paramount, the implementer may opt for a mainly hardware and/or firmware vehicle; if flexibility is paramount, the implementer may opt for a mainly software implementation; or, yet again alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be within the skill of one skilled in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein can be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity; control motors for moving and/or adjusting components and/or quantities). A typical data processing system may be implemented utilizing any suitable commercially available components, such as those typically found in data computing/communication and/or network computing/communication systems. The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermediate components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

While various embodiments have been disclosed herein, other aspects and embodiments will be apparent to those skilled in art.

1. A nuclear magnetic resonance (NMR) sensor configured for deployment in a well or Earth formation, the NMR sensor comprising:
a sensor body configured for deployment in the well or Earth formation;
a magnetic array disposed inside the sensor body and adapted to produce a first magnetic field in a measurement zone; and
a transmit/receive array disposed inside the sensor body, wherein the transmit/receive array is adapted to:
produce a second magnetic field within the measurement zone; and
detect NMR signals emitted from a sample material within the measurement zone;
wherein the first magnetic field and the second magnetic field are adapted for direct detection and measurement of a concentration of a substance comprising non-hydrogen nuclei within the sample material.

2. The NMR sensor of claim 1, further comprising a sample cavity within or adjacent the sensor body, wherein the NMR sensor is configured to receive the sample material inside the sample cavity, and wherein the measurement zone is inside the sample cavity.

3. The NMR sensor of claim 2, further comprising a flow control device configured to control a flow of the sample material into the sample cavity.

4. The NMR sensor of claim 2, wherein the magnetic array and the transmit/receive array substantially surround the sample cavity.

5. The NMR sensor of claim 1, wherein the measurement zone is outside the sensor body.

6. The NMR sensor of claim 5, wherein the measurement zone comprises a zone which substantially surrounds the sensor body.

7. The NMR sensor of claim 6, wherein the magnetic array is substantially centered within the sensor body and wherein the transmit/receive array substantially surrounds the magnetic array.

8. The NMR sensor of claim 7, wherein the first magnetic field has a nonzero spatial gradient within the measurement zone

9. The NMR sensor of claim 5, wherein the measurement zone is focused and vertically elongated.

10. The NMR sensor of claim 9, wherein the magnetic array is offset from a center of the sensor body and wherein the transmit/receive array is positioned substantially alongside of the magnetic array.

11. The NMR sensor of claim 1, wherein the magnetic array and the transmit/receive array are repositionable from within the sensor body into a sidewall of the well or Earth formation.

12. The NMR sensor of claim 10, further comprising an activation mechanism adapted to reposition the magnetic array and the transmit/receive array.

13. The NMR sensor of claim 1, wherein the sample material comprises groundwater and wherein the substance comprising non-hydrogen nuclei comprises a dissolved NMR-sensitive mineral that is dissolved in the groundwater.

14. The NMR sensor of claim 12, wherein the dissolved NMR-sensitive mineral comprises at least one of lithium, phosphorus, or potassium.

15. The NMR sensor of claim 1, wherein the first magnetic field is substantially uniform within the measurement zone.

16. The NMR sensor of claim 14, wherein the substantially uniform magnetic field is adapted to facilitate exclusion of NMR signals produced by hydrogen nuclei.

17. The NMR sensor of claim 1, wherein the transmit/receive array is coupled to surface electronics via a transmission line, and wherein the surface electronics are adapted to control the NMR measurement.

18. The NMR sensor of claim 1, wherein the first magnetic field has a spatial gradient which is approximately zero within the measurement zone.

19. The NMR sensor of claim 1, wherein the sample material comprises groundwater and wherein the substance comprising non-hydrogen nuclei comprises a contaminant.

20. The NMR sensor of claim 1, wherein the contaminant comprises a benzene, toluene, ethylbenzene and xylene (BTEX) substance, a perfluoroalkyl or polyfluoroalkyl (PFAS) substance, a hydrocarbon, or an organic contaminant.
